(19) United States
(12) Patent Application Publication
(10) Pub. No.: US 2003/0024602 A1
(43) Pub. Date: Feb. 6, 2003

(54) Riser apparatus and method for supporting panels for lamination

(76) Inventor: Dusan Petrovic, Rock Hill, SC (US)

Correspondence Address: CARL M. DAVIS II, BAKER , DONELSON, BEARMAN & CALDWELL, 5 CONCOURSE PARKWAY, SUITE 900, ATLANTA, GA, 30328, US

(21) Appl. No.: 09/920,350

(22) Filed: Aug. 1, 2001

(51) Int. Cl. B27L 5/02

(52) U.S. Cl. 144/214

(57) ABSTRACT

A riser (10, 50) for supporting a plurality of panels (66) to be laminated with a plastic laminate sheet (96), which is defined with a press table (12) of a laminating press (14) by a plurality of alternating ridges (20) and channels (22). A plurality of blocks (36) are received in the channels (22) for selective longitudinal movement therein, each of the blocks (36) extending from the channel sufficiently to define a gap (64) between a distal surface (42) of the block (36) and an upper surface of the adjacent ridges (20). The blocks (36) are movable longitudinally in the channels (22) to define wrap gaps (70) between the ends (38, 40) of the blocks (36) and the edges (74) of the panels (66) supported thereon for the plastic laminate sheet (96) to wrap under perimeter edges of the panels during lamination. A method of supporting a plurality of panels to be laminated with a plastic sheet in a laminating press is disclosed. A method of modifying a laminating press with a riser for supporting a plurality of panels to be laminated with a plastic sheet is disclosed. A laminating press having a riser for supporting a plurality of panels to be laminated with a plastic sheet is disclosed.

### TECHNICAL FIELD

The present invention relates to three dimensional vinyl laminating presses such as membrane presses and vacuum formers for laminating panels. More particularly, the present invention relates to riser apparatus for elevating panels during the laminating process.

### BACKGROUND OF THE INVENTION

Kitchens in the typical home have a large number of different sized cabinets. New home construction and remodeling of kitchens often includes replacement or refurbishing of kitchen cabinets. A significant industry has developed in remodeling kitchens by replacing existing cabinet doors with new more modern appearing cabinet doors. The cabinets typically have a number of different sizes of doors.

For many years, the doors used in cabinetry were solid wood panels. In recent years, however, solid wood panels have been replaced with a durable wood-based medium density fiber board (MFD) board to which a plastic laminate is applied. Laminated panels have reduced the cost associated with cabinetry while providing a wide range of attractive ornamental coverings.

Three dimensional laminating presses are used for applying the plastic laminate sheet to panels or other parts. Generally, the laminating presses are machines having a press table and an upper cover. (The upper cover in a membrane press includes a resilient membrane.) The cover moves and closes at a sealing perimeter with the press table to form an airtight chamber. During operation of the laminating press, panels to be laminated are placed on supports on the press table. A plastic sheet with an adhesive on one surface overlies the panels, or alternatively the adhesive may be applied to the face of the panel or part being laminated. The chamber is closed by moving the cover into sealing relation with the press table. The vinyl laminate sheet is then heated, such as by hot air, infrared, or contact with a hot platten. The heated plastic laminate becomes soft so that it may wrap around perimeter edges of the panels. Air is evacuated from beneath the plastic laminate to draw the plastic laminate down to the panels. In a membrane press, pressurized air in the cover forces the membrane against the plastic sheet. The laminate adheres to the panels and the laminate wraps around the perimeter edges and a portion of the lower surface of the panels. After laminating, the cavity is re-filled with air. The cover is opened, and the panels are cut from the plastic sheet.

In laminating presses, the panels sit on the supports and are thereby slightly elevated above the press table. The elevation is required to allow the plastic laminate sheet to wrap or curl under the perimeter edges of the panel. There are a number of different devices provided for elevating panels to be laminated. One mechanism is to use a support board or pedestal that is slightly smaller than the panel to be laminated. This provides a gap between the edge of the pedestal and the edge of the panel so that the plastic laminate can wrap under and contact the underside perimeter edge of the panel being laminated. While the smaller pedestals hold the panel elevated above the press table, there are problems with such devices. The use of pedestals requires an extensive inventory in a range of sizes, typically having half inch increments of between 5 and 30 inches in width and between 5 and 30 inches in length. The operator of the laminating press determines the size and number of panels to be laminated. The inventory is searched to obtain the correct pedestals. These are placed on the press table of the laminating press. The panels are placed on the pedestals and spacing is adjusted to have generally about 3 inches between adjacent panels. After a lamination cycle, the pedestals are returned to the inventory. The activities involved in determining the pedestal sizes needed, obtaining the pedestals from inventory, and returning the pedestals to inventory, are time consuming and labor intensive. The production of laminate panels often involves numerous different sizes, where each cycle has panels sized differently from the previous cycle.

The labor and time problems associated with using inventories of pedestals for laminating panels has been recognized. Different devices have been developed to simplify the laminating process and reduce the labor involved in selecting and returning pedestals to inventory. For example, cubes have been provided whereby a number can be selected and positioned on the press table for supporting the corners of the panels. Another device provides adjustable frames which are capable of adjustment in a length and width direction. This reduces the number of supports that need to be maintained in inventory. However, time is spent in making the adjustments in order to leave the gap between the side of the frame and the side edge of the panel to be laminated, as well as locating the adjustable frames from an inventory of frames, as is done for the pedestals.

Efforts have been made to automate the elevating of panels during the laminating process. For example, U.S. Pat. Nos. 5,529,658 and 5,201,981 describe a plurality of pedestals having fluid actuated pistons move the pedestals to a elevated position.

While these devices have function to elevate panels during laminating, there are drawbacks to their use. These movable pistons need maintenance and their operation increases the complexity of the membrane press. Also, these systems are expensive. As discussed above, some of the devices are labor intensive to select the appropriate pedestal from inventory, place the pedestals on the table of the laminating press, and return the pedestals to inventory.

Accordingly, there is a need in the art for an improved riser for supporting panels in three dimensional laminating presses, which can also be retrofitted into existing presses with minimal modification to the existing press. It is to such that the present invention is directed.

### BRIEF DESCRIPTION OF THE PRESENT INVENTION

The present invention meets the need in the art by providing a riser for supporting a plurality of panels to be laminated with a plastic laminate sheet, in which a platform is defined for a press table of a laminating press by a plurality of alternating ridges and channels. A plurality of blocks are received in the channels for selective longitudinal movement therein, each of the blocks extending from the channel sufficiently to define a gap between a distal surface of the block and an upper surface of the adjacent ridges. The blocks are movable longitudinally in the channels to define wrap gaps between the ends of the blocks and the edges of the panels supported thereon for the plastic laminate sheet to wrap under perimeter edges of the panels during lamination in the laminating press.

In another aspect, the present invention provides a method of supporting a plurality of panels having perimeter edges to be laminated with a plastic laminate sheet, comprising the steps of:

(a) placing a plurality of blocks having opposing distal ends in channels of a platform defined by a plurality of alternating ridges and channels for a press table of a laminating press, each of the blocks extending from the channel sufficiently to define a gap between a distal surface of the block and an upper surface of the adjacent ridges;

(b) placing panels to be laminated in spaced-apart relation on the blocks;

(c) moving the blocks covered by the panels longitudinally in the channels to dispose the end of the block inwardly of one of the perimeter edges of the panel to define a wrap gap,

whereby the wrap gaps between the blocks and the panels supported thereon provide space for the plastic laminate sheet to wrap under perimeter edges of the panels during lamination in the laminating press.

In yet another aspect, the present invention provides a method of modifying a press table of a laminating press to provide a riser for supporting a plurality of panels having perimeter edges to be laminated with a plastic laminate sheet, comprising the steps of:

(a) defining a plurality of alternating ridges and channels for a press table of a laminating press with each ridge having an upper surface; and

(b) providing a plurality of blocks having opposing distal ends for being disposed in the channels selectively for supporting panels thereon, each of the blocks extending from the channel sufficiently to define a gap between a distal surface of the block and an upper surface of the adjacent ridges,

whereby wrap gaps for portions of a plastic laminate sheet to wrap under perimeter edges of the panels during lamination in the membrane press are defined by moving the blocks longitudinally in the channels to dispose the end of the block inwardly of one of the perimeter edges of the panel being at least partially supported by the block.

In yet another aspect, the present invention provides a laminating press for laminating plastic sheet to panels with a press table having a perimeter seal edge and a cover housing, the cover housing selectively engageable with the press table to define a sealed cavity. A riser is defined by a plurality of alternating ridges and channels for supporting on the press table a plurality of panels to be laminated. A plurality of blocks having opposing distal ends are received in the channels for selective longitudinal movement therein, each of the blocks extending from the channel sufficiently to define a gap between a distal surface of the block and an upper surface of the adjacent ridges. A vacuum source provides for selectively evacuating air from the sealed cavity. Panels to be laminated by a plastic sheet disposed thereon are supported on the blocks that are moved longitudinally in the channels to define wrap gaps between the ends of the blocks and the perimeter edges of the panels supported thereon. The wrap gaps provide space for the plastic laminate sheet to wrap under perimeter edges of the panels during lamination when the vacuum source evacuates the air from the sealed cavity.

Objects, features, and advantages of the present invention will become apparent from a reading of the following detailed description of the invention and claims in view of the appended drawings.

### BRIEF DESCRIPTION OF THE DRAWINGS

FIG. 1 is a perspective cut-away view of a riser attached to a press table of a laminating press, in accordance with the present invention.

FIG. 2 is an exploded view of a second embodiment of a riser according to the present invention for supporting a panel on a press table of a laminating press according to the present invention.

FIG. 3 is a side view of a membrane press having the riser according to the present invention.

FIG. 4 is a side view of the membrane press illustrated in FIG. 3 during the laminating process.

### DETAILED DESCRIPTION OF THE PREFERRED EMBODIMENTS

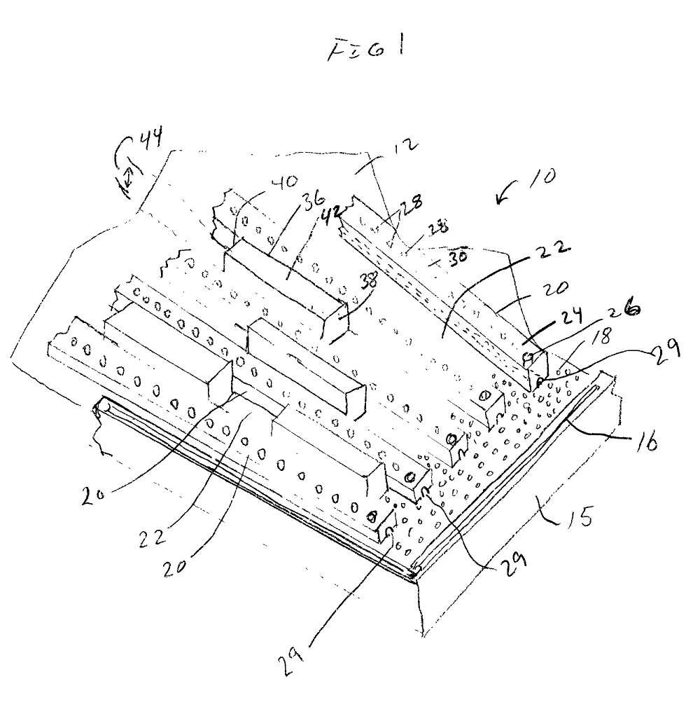

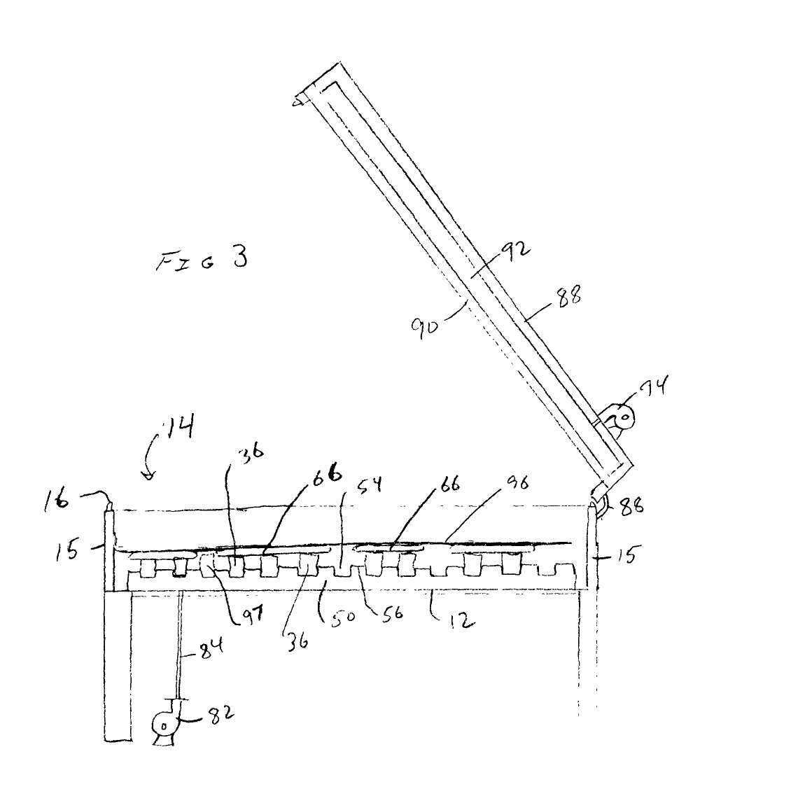

Referring now in more detail to the drawings, in which like numerals indicate like parts throughout the several views, FIG. 1 is a perspective, partially cut-away view of a riser 10 attached to a press table 12 of a membrane press 14 best illustrated in FIG. 3, in accordance with the present invention. The press table 12 includes sidewalls 15 that define on an upper edge a sealing perimeter 16, such as with a gasket. The press table 12 of the illustrated embodiment includes a plurality of passages generally 18 for communicating air into and from a cavity defined by the press table 12 and a cover for the membrane press 14, as discussed below.

The riser 10 supports a plurality of panels to be laminated with a plastic laminate sheet. With continued reference to FIG. 1, the riser 10 is defined by a plurality of spaced-apart ridges 20 and channels 22. In the illustrated embodiment, the ridges 20 are defined by a plurality of spaced-apart elongate members which are rigidly attached to the press table 12, such as by rivets 26. In the illustrated embodiment, the ridges 20 are ⅛ inch high, ¼ inch wide, and spaced ¾ inch apart. Other widths may be used depending on the particular application. Each of the elongate members 24 defines a plurality of spaced-apart pathways 28 from an upper surface 30 through the member. The members 24 accordingly define alternating ridges 20 and channels 22. In an alternate embodiment, the channels 22 are machined into a press table 12 to define the alternating ridges 20 and channels 22.

The pathways 28 communicate air through the riser 10, and thus communicate with the passages 18. In the illustrated embodiment, this is facilitated by including a thin groove 29 in a bottom surface which interconnects with at least two of the pathways 28. Preferably, the groove extends the length of the elongate member to include all of the pathways 28 in a ridge. The grooves 29 define a common plenum for the pathways 28. The groove 29 is approximately 1/16 inch.

A plurality of blocks 36 are selectively received in spaced-apart relation in the channels 22. The blocks 36 have opposing distal ends 38, 40 and are configured for moving longitudinally in the channels 22. The blocks 36 are sized so that an upper surface 42 is spaced farther from the press table 12 than is the upper surface 30 of the ridges 20. This defines a gap generally 44 between the upper surfaces 30 of the ridges 20 and the upper surfaces 42 of the blocks 36. As discussed below, the blocks 36 support wood boards or panels which are to be laminated with plastic sheets in the laminating press.

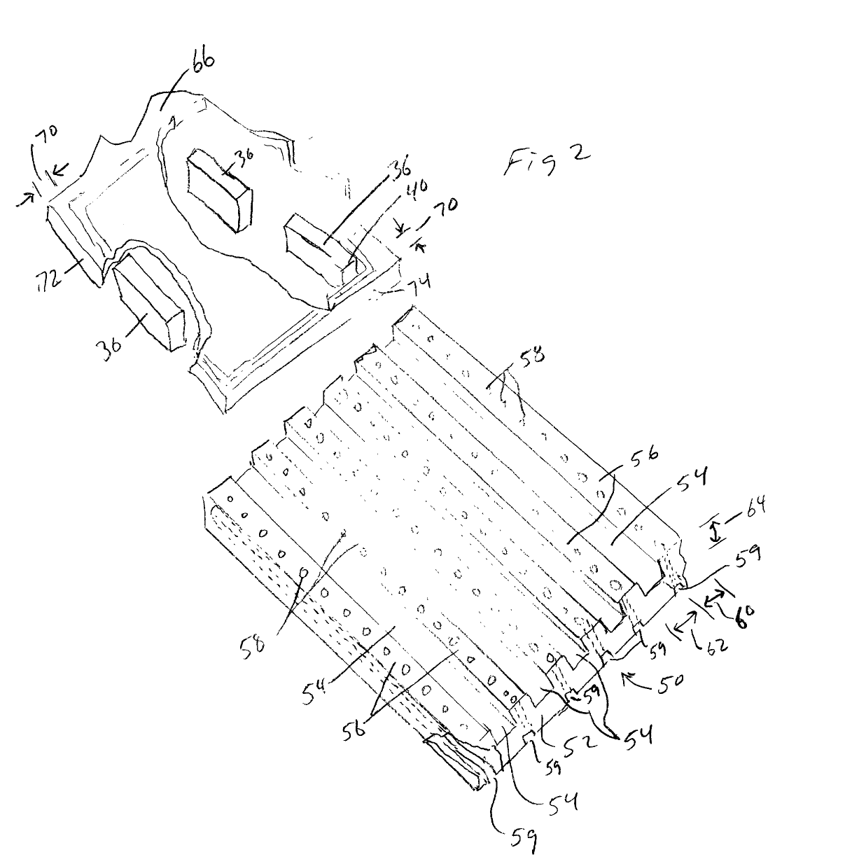

FIG. 2 is an exploded perspective view of an alternate embodiment of a riser 50 formed from a plate 52. A plurality of channels 54 are formed in an upper surface of the plate 52. The channels 54 are cut or machined. This defines a plurality of ridges 56 alternating with the channels 54 in the riser 50. In the illustrated embodiment of the plate 52, a plurality of spaced-apart pathways 58 are formed through the ridges 56 between a upper surface and a lower surface. Although not illustrated, the pathways 58 could likewise be formed in the channels 54.

A plenum is preferably defined for the plate 52 to facilitate communication of air through the pathways 58. For example, the riser 10 may be formed directly in the press table 12. Alternatively, for a retrofit application, the plate 52 defines grooves 59 in a bottom surface that interconnect the pathways 58, as shown in FIG. 3 in partial cut-away view. Also, the plate 52 may be supported on the press table 12 by a air permeable board, such as peg board or the like, on a mesh screen.

In the illustrated embodiment, the plate 52 is a ¼ inch plastic or metallic sheet. The ridges 56 have a width 60 of ¼ inch while the channels 54 have a width 62 of ¾ inch. The channels 54 have a depth 64 of ⅛ inch. The groove 59 is 1/16 inch. These dimensions may be changed for a particular application without departing from the alternating ridges and channels and movable blocks in the channels.

Exploded away from the plate 52 is a plurality of the blocks 36. The blocks 36 are illustrated supporting a wood panel door 66 partially cut-away to illustrate features of the present invention. The panels 66 and the blocks 36 are positioned relative to each other in order to provide a wrap gap 70 between a perimeter edge 72 and the blocks 36. Also as shown in FIG. 2, a wrap gap 70 is defined between a perimeter edge of an end 74 of the panel 66 and a distal end 40 of one of the blocks 36. The wrap gaps 70 are defined by spacing the blocks 36 supporting the panels 66 apart from the perimeter edges 72 of the panels, with the blocks 36 supporting the panels 66 spaced-apart from the ridges 56. The blocks in the illustrated embodiment are ¾ inch square in cross-sectional end view. This provides a ⅝ inch gap between the upper surface of the ridges and the blocks. For typical panel doors, this is sufficient. For thicker panels, the height of the blocks 36 should be increased to provide a gap space for the plastic sheet to wrap under the edge.

FIG. 3 is a cut-away side view of the laminating press 14 having the riser 50 received on the press table 12. In the illustrated embodiment, the laminating press 14 is a membrane type laminating press. In alternate embodiments the riser 10 illustrated in FIG. 1 is defined by fixing the elongate members 24 in spaced-apart relation on the press table 12. It is to be appreciated that the riser of the present invention may be defined integral with a press table for a laminating press.

The press table 12 communicates with a blower 82 through a conduit 84. A cover 86 attaches by a hinge 88 to a side wall of the press table 12. The cover 88 includes a flexible membrane 90 which defines a recess 92 that communicates with a blower 94 for communicating air into the cavity 92. (Other types of laminating presses do not use the flexible membrane to effect lamination.) The riser 50 includes a plurality of the blocks 36 selectively disposed in the channels 54. The blocks support a plurality of panels 66 spaced-apart in the membrane press 80. A plastic laminate sheet 96 overlays the panels 66. It is to be appreciated that the scale for the ridges and channels is exaggerated for purposes of illustration.

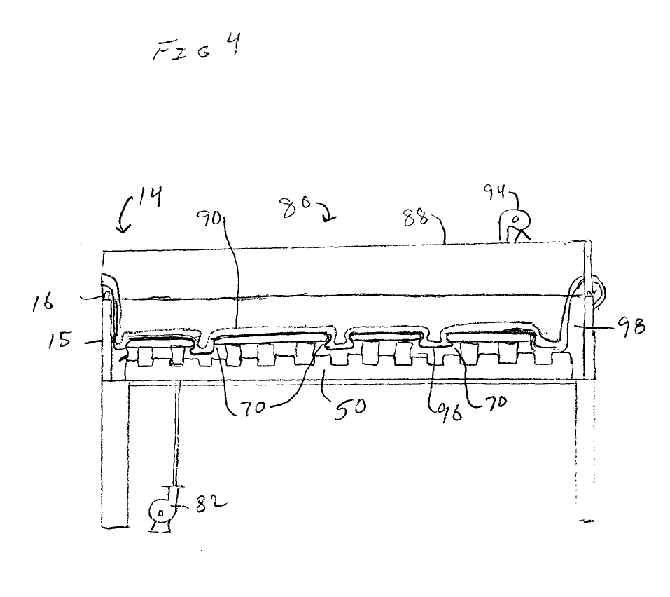

The riser apparatus 10 and 50 of the present invention is used to support a plurality of wood panels 66 as illustrated in FIGS. 3 and 4 during lamination. The blocks 36 are placed in the channels 54 and the panels 66 are placed on the blocks. The blocks 36 are moved longitudinally in the channels 54 so that the distal ends 38, 40 of the blocks 36 are at least spaced-apart a sufficient distance or wrap gap 70 to allow the plastic sheet 96 to wrap under the perimeter edge of the panel 66. In the event that one of the blocks 36 is too close an edge of a panel 66, such as the phantom-line block 97 shown in FIG. 3, the block is removed from the channel. Although not discussed, the riser 10 is similarly used to support panels 66 on the blocks 36 moved in the channels 22 between the ridges 20.

After the blocks 36 and the panels 66 are positioned to provide sufficient wrap gaps 70 around the perimeter edges, the cover 88 is pivoted closed to form the airtight cavity 92 in the membrane press 14. The laminate sheet 96 is heated by hot air, infrared, contact, or other heating device. After an appropriate interval, the air is evacuated using the blower 82. This creates a vacuum in the cavity 92 and pulls the laminate sheet 96 firmly downward against the panels 66. The pathways 58 in the ridges 56 communicate the air to the blower 82 through the press table 12. The plenum, such as that defined by the grooves 59, cooperatively communicates the air. Alternatively, the plenum may be defined by a wire mesh between the plate 52 and the press table 12, or other air permeable spacer. The blower 94 is operated in order to force the membrane 90 against the laminate sheet 96 and to assist wrapping the laminate sheet 96 into the wrap gaps 70 and around the perimeter edges of the panels 66 held on the blocks 36.

After lamination, the pressurized air in the cover 88 is removed in order to release the membrane 90 from bearing contact against the plastic sheet 96. Air is reintroduced into the cavity 92. The cover 88 is opened and the laminated panels 66 are cut from the sheet 96.

The present invention accordingly provides the riser for supporting the plurality of panels sufficiently apart from the press table of the laminating presses so as to allow the plastic laminate sheet to wrap under perimeter edges of the panels during lamination, together with a method of supporting the panels for lamination on the riser, a method of modifying an existing laminating press with the riser, and the improved laminating press having the riser for supporting the panels to be laminated. The principles, preferred embodiments, and modes of operation of the present invention have been described in the foregoing specification. The invention is not to be construed as limited to the particular forms disclosed because these are regarded as illustrative rather than restrictive. Moreover, variations and changes may be made by those skilled in the art without departure from the spirit of the invention as described by the following claims.

What is claimed is:

1. A riser for supporting a plurality of panels having perimeter edges to be laminated with a plastic laminate sheet, comprising:
a platform defined for a press table of a laminating press by a plurality of alternating ridges and recesses;
a plurality of blocks having opposing distal ends received in the recesses for selective longitudinal movement therein, each of the blocks extending from the recess sufficiently to define a gap between a distal surface of the block and an upper surface of the adjacent ridges,
whereby the blocks, being moved longitudinally in the recesses define wrap gaps between the ends of the blocks and the edges of the panels supported thereon for the plastic laminate sheet to wrap under perimeter edges of the panels during lamination in the laminating press.

2. The riser as recited in claim 1, wherein the platform defines a plurality of pathways through the platform for communicating air into and from the gaps during the laminating process.

3. The riser as recited in claim 2, wherein the pathways are defined in spaced-apart relation in the ridges.

4. The riser as recited in claim 3, wherein the pathways in a ridge are interconnected on a bottom surface by a groove.

5. The riser as recited in claim 1, wherein the platform comprises a body in which the plurality of recesses are formed to define the alternating ridges and recesses.

6. The riser as recited in claim 5, wherein the body defines a plurality of pathways for communicating air into and from the gaps during the laminating process.

7. The riser as recited in claim 6, wherein the pathways in a ridge are interconnected on a bottom surface by a groove.

8. The riser as recited in claim 5, further comprising a plenum for commonly connecting at least two of the pathways.

9. The riser as recited in claim 1, wherein each ridge comprises an elongate member attached to the press table in spaced-apart relation to an adjacent one of the elongate members, thereby defining the alternating ridges and recesses.

10. The riser as recited in claim 9, wherein each elongate member defines a plurality of spaced-apart pathways for communicating air into and from the gaps during the laminating process.

11. The riser as recited in claim 10, wherein the pathways in a ridge are interconnected on a bottom surface by a groove.

12. A method of supporting a plurality of panels having perimeter edges to be laminated with a plastic laminate sheet, comprising the steps of:
(a) placing a plurality of blocks having opposing distal ends in recesses of a platform defined by a plurality of alternating ridges and recesses for a press table of a laminating press, each of the blocks extending from the recess sufficiently to define a gap between a distal surface of the block and an upper surface of the adjacent ridges;
(b) placing panels to be laminated in spaced-apart relation on the blocks;
(c) moving the blocks covered by the panels longitudinally in the recesses to dispose the end of the block inwardly of one of the perimeter edges of the panel to define a wrap gap,
whereby the wrap gaps between the blocks and the panels supported thereon provide space for the plastic laminate sheet to wrap under perimeter edges of the panels during lamination in the laminating press.

13. The method of supporting as recited in claim 12, further comprising the step of removing at least one of the plurality of blocks from the recess for panels which have an edge that does not provide sufficient room for the wrap gap.

14. The method of supporting as recited in claim 12, further comprising the step of communicating air from the gaps through pathways defined in the platform.

15. The method of supporting as recited in claim 14, further comprising the step of communicating air for at least two of the pathways in a common plenum.

16. A method of modifying a press table of a laminating press to provide a riser for supporting a plurality of panels having perimeter edges to be laminated with a plastic laminate sheet, comprising the steps of:
(a) defining a plurality of alternating ridges and recesses for a press table of a laminating press with each ridge having an upper surface; and
(b) providing a plurality of blocks having opposing distal ends for being disposed in the recesses selectively for supporting panels thereon, each of the blocks extending from the recess sufficiently to define a gap between a distal surface of the block and an upper surface of the adjacent ridges,
whereby wrap gaps for portions of a plastic laminate sheet to wrap under perimeter edges of the panels during lamination in the laminating press are defined by moving the blocks longitudinally in the recesses to dispose the end of the block inwardly of one of the perimeter edges of the panel being at least partially supported by the block.

17. The method of modifying a press table as recited in claim 16, wherein step (a) comprises attaching a plurality of elongate members in spaced-apart relation to the press table of the membrane press.

18. The method of modifying a press table as recited in claim 16, wherein step (a) comprises placing on the press table a body in which the plurality of recesses are cut to define the alternating ridges and recesses.

19. The method of modifying a press table as recited in claim 16, further comprising the step of providing a plenum for common communication of air through the riser.

20. A laminating press for laminating plastic sheet to panels, comprising:
a press table having a perimeter seal edge;
a cover housing that is selectively engageable with the press table to define a sealed cavity;
a riser defined by a plurality of alternating ridges and recesses for supporting on the press table a plurality of panels to be laminated;
a plurality of blocks having opposing distal ends received in the recesses for selective longitudinal movement therein, each of the blocks extending from the recess sufficiently to define a gap between a distal surface of the block and an upper surface of the adjacent ridges; and
a vacuum source for selectively evacuating air from the sealed cavity,
whereby panels to be laminated by a plastic sheet disposed thereon are supported on the blocks that are moved longitudinally in the recesses to define wraps gaps between the ends of the blocks and the perimeter edges of the panels supported thereon to provide space for the plastic laminate sheet to wrap under perimeter edges of the panels during lamination in the laminating press.

21. The laminating press as recited in claim 20, wherein the riser defines a plurality of pathways through the riser for communicating air into and from the gaps during the laminating process.

22. The laminating press as recited in claim 21, further comprising a plenum for common communication of the air for at least two of the pathways.

23. The laminating press as recited in claim 21, wherein the pathways are defined in spaced-apart relation in the ridges.

24. The laminating press as recited in claim 20, wherein the riser comprises a body in which the plurality of recesses are formed to define the alternating ridges and recesses.

25. The laminating press as recited in claim 24, wherein the body defines a plurality of pathways for communicating air into and from the gaps during the laminating process.

26. The laminating press as recited in claim 25, further comprising a plenum for common communication of the air for at least two of the pathways.

27. The laminating press as recited in claim 20, wherein each ridge comprises a plurality of elongate members attached to the press table in spaced-apart relation to an adjacent one of the elongate members, thereby defining the alternating ridges and recesses.

28. The laminating press as recited in claim 27, wherein each elongate member defines a plurality of spaced-apart pathways for communicating air into and from the gaps during the laminating process.

29. The laminating press as recited in claim 28, wherein each ridge comprises a plurality of elongate members attached to the press table in spaced-apart relation to an adjacent one of the elongate members, thereby defining the alternating ridges and recesses.

30. The laminating press as recited in claim 20, wherein the riser is integral with the press table.
